(19) United States
(12) Patent Application Publication
(10) Pub. No.: US 2026/0202235 A1
(43) Pub. Date: Jul. 16, 2026

(54) Handheld Digital Scale with Interchangeable Head

(71) Applicant: Francois Saliba, Toronto (CA)

(72) Inventor: Francois Saliba, Toronto (CA)

(21) Appl. No.: 19/015,858

(22) Filed: Jan. 10, 2025

(51) Int. Cl. G01G 19/56; G01G 17/04; G01G 21/28; G01G 23/16; G01G 23/37; G01G 23/42

(52) U.S. Cl. CPC G01G 19/56; G01G 17/04; G01G 21/283; G01G 23/163; G01G 23/3714; G01G 23/3728; G01G 23/42

(57) ABSTRACT

A handheld digital scale with an interchangeable head is provided. The handheld digital scale includes a scale body with a digital display on its surface and user input buttons, including a tare function and unit selection for switching between measurement units. The scale body includes a female fastener that can removably attach to the interchangeable head. The interchangeable head includes a recess at one end to hold materials and a male fastener at the opposite end for secure attachment to the scale body. The scale detects the weight of materials placed within the recess and displays the measurement on the digital display. The interchangeable heads are available in various forms, such as spoons, scoops, or bowls, to accommodate different materials, including food items like protein powder and peanut butter. The scale further integrates ergonomic design features for user comfort and optional wireless connectivity for data tracking via a software application.

### BACKGROUND OF THE INVENTION

The present invention relates to handheld digital scales with interchangeable heads. More specifically, the present invention pertains to a handheld weighing device comprising a scale body with a contoured ergonomic structure, an integrated digital display, and a modular system of interchangeable heads configured to provide precise weight measurements for diverse food items, through a secure fastening mechanism.

Digital scales are widely used in kitchens, laboratories, and other settings for precise weighing of small quantities of materials. Many existing scales are limited by fixed weighing platforms that lack adaptability for different types of materials or specific use cases. For example, conventional kitchen scales often require users to use separate utensils, such as spoons or scoops, to transfer materials onto the weighing surface. This additional step not only creates inefficiency but also introduces the potential for inaccuracies caused by spillage or improper placement of materials.

Some digital scales with detachable weighing trays attempt to address this issue but fail to provide a seamless user experience. These designs are often cumbersome, lack ergonomic considerations, and offer limited compatibility with various utensils. Furthermore, such scales typically lack advanced features like data tracking, calorie calculation, or wireless connectivity, which could significantly enhance their utility in modern applications. Users seeking to measure sticky or viscous substances, such as peanut butter or honey, frequently face difficulties in retrieving all the material, leading to wastage and added frustration.

Additionally, many existing scales are not designed with user comfort in mind. Their shapes, button placement, and weight distribution often result in discomfort during extended use. The lack of robust fastening mechanisms for interchangeable components can also lead to instability and reduced accuracy during operation. As a result, current solutions fail to meet the evolving needs of consumers who require a reliable, versatile, and user-friendly weighing device.

Therefore, a need exists for a handheld digital scale with interchangeable heads configured to provide a tailored weighing solution by allowing users to select heads designed for specific materials, such as spoons, scoops, or bowls of varying sizes. Th scale body further comprises an ergonomic design for ease of handling, advanced functionalities like tare adjustments and unit conversions, and wireless connectivity to record and track data through a companion application. These features would enable precise and efficient weighing while enhancing user experience and addressing the shortcomings of existing devices.

In light of the devices disclosed in the known art, it is submitted that the present invention substantially diverges in design elements and methods from the known art and consequently it is clear that there is a need in the art for an improvement for a handheld digital scale with an interchangeable head. In this regard the instant invention substantially fulfills these needs.

### SUMMARY OF THE INVENTION

In view of the foregoing disadvantages inherent in the known types of handheld digital scales with interchangeable heads now present in the known art, the present invention provides a new handheld digital scale with an interchangeable head having a scale body with a contoured ergonomic structure, an integrated digital display, and a modular system of interchangeable heads configured to provide precise weight measurements for diverse material.

It is an objective of the present invention to provide a handheld digital scale with an interchangeable head that allows users to accurately measure the weight of materials. The invention comprises a scale body with a digital display and interchangeable heads, such as spoons, scoops, or bowls, which can be securely attached to the scale body. The interchangeable heads are configured to accommodate a variety of materials, including food items like protein powder and peanut butter.

It is an objective of the present invention to provide a handheld digital scale with an interchangeable head wherein the scale body is contoured to fit in the user's hand, with strategically placed buttons for easy one-handed operation. The digital display is angled for optimal visibility, and the lightweight construction ensures reduced user fatigue during extended use.

It is an objective of the present invention to provide a handheld digital scale with an interchangeable head wherein the scale body includes a tare function for resetting measurements, a unit selection option to toggle between ounces and grams, and a rechargeable battery for long-lasting performance.

It is an objective of the present invention to provide a handheld digital scale with an interchangeable head configured to provide a secure male-to-female fastener mechanism to ensure stability during operation and minimize inaccuracies caused by head movement.

It is therefore an object of the present invention to provide a new and improved handheld digital scale with an interchangeable head that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows an exploded view of an embodiment of the handheld digital scale with an interchangeable head.

FIG. 2 shows a side view with a partial cross-sectional view of an embodiment of the handheld digital scale with an interchangeable head.

FIG. 3 shows a side view with a partial cross-sectional view of an embodiment of the handheld digital scale with an alternate interchangeable head.

FIG. 4 shows a block diagram of an embodiment of the handheld digital scale with an interchangeable head.

### DETAILED DESCRIPTION OF THE INVENTION

Reference is made herein to the attached drawings. For the purpose of presenting a brief and clear description of the present invention, the preferred embodiment will be discussed as used for precise weight measurements for diverse materials. The figures are intended for representative purposes only and should not be considered to be limiting in any respect.

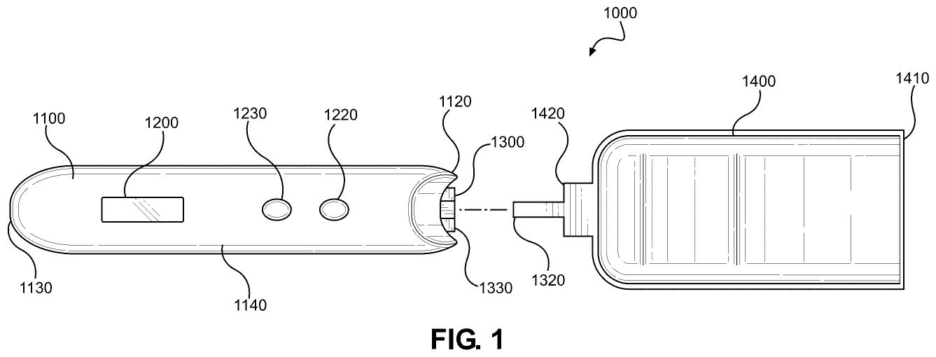

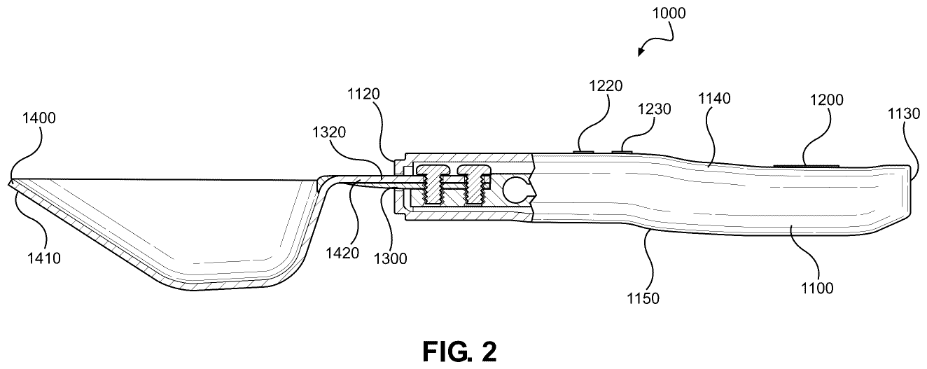

Referring to FIGS. 1 and 2, there is shown an exploded view and a side view of an embodiment of the handheld digital scale with an interchangeable head, respectively. In the illustrated embodiment, the handheld digital scale 1000 comprises a scale body 1100 having a first end 1120, a second end 1130, an upper side 1140, and a lower side 1150. The scale body 1100 forms the primary structural component of the handheld digital scale 1000 and is ergonomically contoured for user comfort. The scale body is approximately 6 to 8 inches in length, 2 to 3 inches in width, and 1 to 1.5 inches in height, with its surface composed of lightweight, durable materials such as high-density plastic or aluminum alloy to ensure portability and robustness.

The upper side 1140 of the scale body 1100 includes a digital display 1200 centrally located for clear visibility during use. The digital display 1200 provides real-time weight measurements in various units, including grams and ounces, selectable via a unit selection button 1220 disposed adjacent to the display. A tare button 1230 is also provided on the upper side 1140, allowing users to reset the displayed weight to zero before adding additional materials. In some embodiments, the buttons 1220, 1230 are recessed to prevent accidental activation during use or storage.

In the shown embodiment, a female fastener 1300 is disposed at the first end 1120 of the scale body 1100. The female fastener 1300 is configured to receive a male fastener 1320 extending from a corresponding interchangeable head 1400. The female fastener 1300 comprises an internal locking mechanism with detents to securely hold the male fastener 1320 in place during operation, preventing unintended detachment or instability. An alignment guide 1330 within the female fastener 1300 is configured to provide proper attachment of the interchangeable head 1400. In the illustrated embodiment, the alignment guide comprises a central recessed groove and a pair of raised ridges disposed on either side of the recessed groove. The groove is dimensioned to correspond in width matching the width of the male fastener of the interchangeable head. The groove and ridges are symmetrically arranged around the central axis of the female fastener, ensuring that the male fastener aligns correctly regardless of the orientation during insertion. In some embodiments, the alignment guide also incorporates tapered edges at the opening of the grooves to facilitate smooth engagement during the attachment process. This taper is configured to reduce resistance as the male fastener is inserted, guiding it into the correct position.

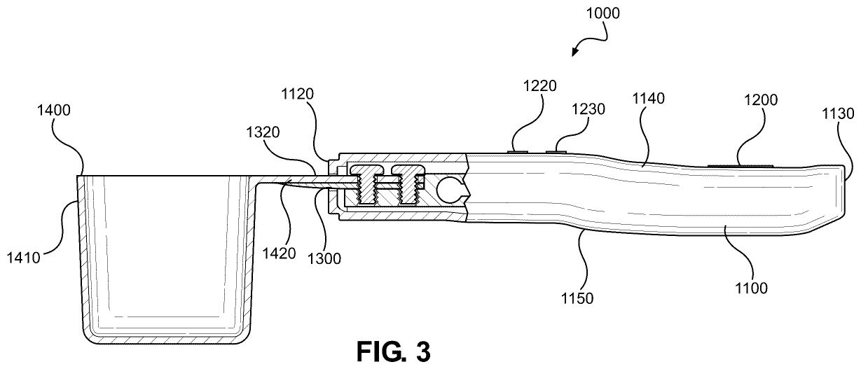

The interchangeable head 1400 includes a first end 1410 configured as a recess for holding materials to be weighed, and a second end 1420 comprising the male fastener 1320 for attachment to the scale body 1100. In the illustrated embodiment, as well as in FIG. 3, the interchangeable head 1400 is designed in various forms, such as a spoon, a scoop, or a bowl, to accommodate different types of materials, including powders, liquids, and sticky substances. The heads are fabricated from food-safe materials, such as stainless steel or high-density polyethylene, ensuring durability and ease of cleaning.

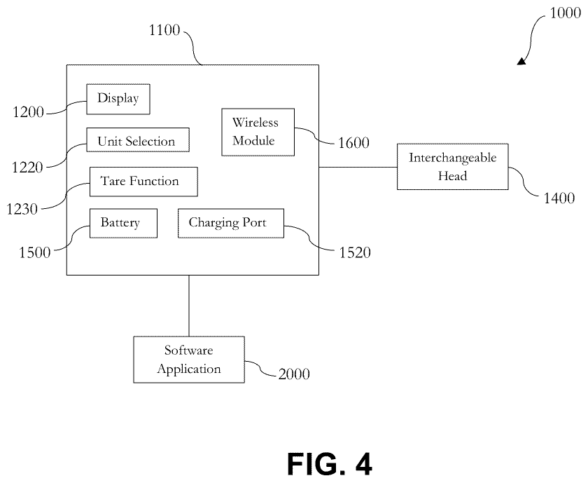

Referring now to FIG. 4, there is shown a block diagram of an embodiment of the handheld digital scale with an interchangeable head. In use, the handheld digital scale 1000 operates by first attaching a selected interchangeable head 1400 to the scale body 1100. The male fastener of the head is aligned with and inserted into the female fastener of the scale body, where the internal locking mechanism engages to secure the connection. The user then places the material to be measured into the recess of the interchangeable head 1400. The scale detects the weight of the material through an integrated load cell positioned beneath the female fastener and displays the measurement on the digital display 1200. In the illustrated embodiment, the load cell is a transducer that converts the force exerted by the material placed in the interchangeable head into an electrical signal, which the scale's electronics process and display as a weight measurement on the digital display. When weight is applied to the interchangeable head, the force transfers through the female fastener to the load cell, causing the sensing element to deform slightly. This deformation changes the resistance in the strain gauges, and the resulting variation in electrical output is proportional to the applied weight.

The scale body 1100 further incorporates a rechargeable battery 1500 and a charging port 1520 located on the lower side. The battery provides sufficient power for extended usage, and an automatic shutoff feature conserves energy by deactivating the scale after a predetermined period of inactivity. The wireless communication module 1600, integrated into the scale body, allows the device to transmit weight data to a companion software application 2000 downloadable to a smart device.

The companion application 2000 enables users to record weight measurements, calculate nutritional information, and set dietary goals. In the illustrated embodiment, the application includes a database of food items with corresponding caloric values. When a material is weighed, the application calculates the caloric content based on the weight and displays the result. The application also supports meal planning and progress tracking, enhancing the utility of the handheld digital scale 1000.

In another embodiment, the interchangeable heads 1400 include non-stick coatings, such as polytetrafluoroethylene (PTFE), to facilitate the measurement of sticky or viscous substances. Heads may also be dishwasher-safe for easy cleaning. The modular design of the scale 1000 allows users to switch between different heads quickly, providing versatility for various applications, including kitchen use, laboratory measurements, or general-purpose weighing tasks. The ergonomic design of the scale body 1100 ensures user comfort during operation. The contoured sides 1700 provide a secure grip, while the lightweight construction reduces fatigue. The angled digital display 1200 and placed buttons 1220, 1230 enable intuitive one-handed operation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, system and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A handheld digital scale with an interchangeable head, comprising:
a handheld scale body having:
a first end configured to receive the interchangeable head;
a digital display disposed on the scale body;
a plurality of user input buttons including a tare function and a unit selection function to toggle between measurement units;
a female fastener disposed at the first end;
the interchangeable head having:
a first end comprising a recess to hold a material to be weighed;
a second end comprising a male fastener configured to removably attach to the female fastener of the handheld scale body;
wherein an assembled configuration the handheld scale is operably connected to the interchangeable head and configured to measure a weight of the material placed within the recess and display the weight on the digital display.

2) The handheld digital scale of claim 1, wherein the interchangeable head is selected from a group consisting of a spoon, a scoop, and a bowl.

3) The handheld digital scale of claim 1, wherein the digital display is configured to show weight measurements in at least two units of measurement, including ounces and grams.

4) The handheld digital scale of claim 1, wherein the scale body further comprises a rechargeable battery and a charging port disposed on a side surface of the scale body.

5) The handheld digital scale of claim 1, wherein the user input buttons include a memory function configured to store and recall previous measurements.

6) The handheld digital scale of claim 1, wherein the female fastener includes an internal locking mechanism to secure the interchangeable head in place during use.

7) The handheld digital scale of claim 1, wherein the male fastener of the interchangeable head includes an alignment guide.

8) The handheld digital scale of claim 1, wherein the scale body is elongated and contoured to align with a palm of a hand when gripped.

9) The handheld digital scale of claim 1, further comprising an automatic shutoff feature configured to power down the scale after a predetermined period of inactivity.

10) The handheld digital scale of claim 1, wherein the recess of the interchangeable head includes a non-stick coating to facilitate the weighing of sticky or viscous materials.

11) The handheld digital scale of claim 1, wherein the scale body further comprises a wireless communication module configured to transmit weight data to an external device such as a smartphone or tablet.

12) The handheld digital scale of claim 1, wherein the tare function is operable via a touch-sensitive button on the digital display.

13) The handheld digital scale of claim 1, wherein the scale is configured to weigh materials within a range of 0.1 grams to 1 kilogram with an accuracy of ±0.1 grams.

14) The handheld digital scale of claim 1, wherein the scale body further comprises a wireless communication module configured to connect to a software application downloadable to a smart device.

15) The handheld digital scale of claim 14, wherein the software application includes a database of food items and their nutritional information.

16) The handheld digital scale of claim 14, wherein the software application calculates the caloric content of a measured food item based on the weight transmitted by the scale and the nutritional information in the database.

17) The handheld digital scale of claim 14, wherein the software application provides real-time feedback on weight measurements displayed on the connected smart device.

18) The handheld digital scale of claim 14, wherein the software application generates a daily log of measured food items, including their weights and calculated nutritional values.

19) The handheld digital scale of claim 14 wherein the software application includes a user profile feature that allows customization of dietary goals and tracks progress over time.

20) The handheld digital scale of claim 14, wherein the software application supports sharing of recorded weight and nutritional data with third-party fitness or health applications.
